(19) United States
(12) Patent Application Publication
(10) Pub. No.: US 2014/0210732 A1
(43) Pub. Date: Jul. 31, 2014

(54) Control Method of Touch Control Device

(71) Applicant: Wen-Fu Chang, Hsinchu City (TW)

(72) Inventor: Wen-Fu Chang, Hsinchu City (TW)

(21) Appl. No.: 13/786,523

(22) Filed: Mar. 6, 2013

(30) Foreign Application Priority Data
Jan. 25, 2013 (TW) 102102968

(51) Int. Cl. G06F 3/0484

(52) U.S. Cl. CPC G06F 3/0484
USPC 345/173

(57) ABSTRACT

Disclosed is a control method of touch control device provided for instinctively controlling a touch control device in various manners. The control method includes steps as follows. While a touching movement is sensed on a touch panel of the touch control device, detecting a sliding trace of the touching movement; obtaining a determined result by distinguishing whether the sliding trace passes through a boundary component or not and by distinguishing whether the sliding trace passes through a edge portion of the boundary component or not; executing a presetting action according to the determined result.

### FIELD OF THE INVENTION

The present invention relates to a control method of touch control device, and more particularly to a control method for executing action according to a sliding style that a sliding trace passes through a boundary.

### BACKGROUND OF THE INVENTION

In trend of rapidly development of the technology, a touch panel has been broadly used as an operating interface for a variety of touch control devices, such as computers (e.g. desktop computers, notebooks, and tablet computers) and mobile devices (e.g. cellular phones and personal digital assistant devices).

The touch panel is used for detecting the touching position of an object, such as a finger or a touch pen, that touches the surface of the touch panel. It commonly displays a plurality of icons on the touch panel, where each icon is corresponding to a program that a specific software object will run. Accordingly, a user can execute the specific software object by clicking the targeted icon for requesting the touch control device to execute a software program.

With the improvement of the touch control devices, more and more program menus and icons are allocated on the touch panel. However, the size of the touch panel is limited, so a user becomes needs to operate a touch panel by switching several pages and click many icons or symbols for a single purpose of operation.

### SUMMARY OF THE INVENTION

In view of the description mentioned above, it requests a lot of selecting steps in page switching and needs to take time to repeat controlling the clicking action of the touch control device. It is thus not intuitive for users and much hardware resource of the touch control device is wasted. Therefore, it becomes an important issue to simplify a control method for operating the touch control device.

Accordingly, an aspect of the present invention is to provide a control method of touch control device to solve the problems.

The control method of the present invention includes steps as follows. (a) detecting a sliding trace of a touching movement on a touch panel; (b) obtaining a determined result by distinguishing whether the sliding trace passes through a boundary component of the touch panel or not and by distinguishing whether the sliding trace passes through an edge portion of the boundary component or not; and (c) executing a presetting action according to the determined result.

According to an embodiment of the present invention, the shape of the boundary component is a shape selected from a group including frame-shaped form, strip-shaped form, and spot-shaped form.

According to an embodiment of the present invention, the boundary component appears on the touch panel or is hidden from view on the touch panel.

According to an embodiment of the present invention, the touch panel is provided with a plurality of boundary components, at least two of the plurality of the boundary components are commonly used for corresponding to an execution action, and in the step (c) while the sliding trace is distinguished as having a trace be passing through a plurality of boundary components that commonly corresponding to an execution action, or the siding trace is distinguished as having a trace be passing through the edge portions of the plurality of boundary components that commonly corresponding to an execution action, then a presetting action that runs the execution action is executed.

According to an embodiment of the present invention, in the step (b), it further includes a step of determining a direction of the sliding trace that passes through the boundary component or a direction of the sliding trace that passes through the edge portion of the boundary component.

According to an embodiment of the present invention, the touch panel is provided with a target area, the target area corresponds to a corresponding target action, in the step (c) while the sliding trace is distinguished as having a trace be passing through the boundary component or through the edge portion of the boundary component, and the sliding trace is distinguished as having a trace be sliding over the target area, then a presetting action of the corresponding target action is executed.

According to an embodiment of the present invention, in the step (c), the presetting action is a corresponding target action that corresponds to a target area nearest to the sliding trace.

According to an embodiment of the present invention, the boundary component has a plurality of subsidiary boundary components, and each subsidiary boundary component corresponds to a corresponding target action respectively.

According to an embodiment of the present invention, the boundary component has a plurality of subsidiary boundary components, and at least two of the plurality of the subsidiary boundary components commonly used for corresponding to a co-corresponding action.

According to an embodiment of the present invention, the boundary component has a region portion, the region portion corresponds to a corresponding target action, in the step (c), while the sliding trace is distinguished as having a trace be passing through the boundary component or the edge portion of the boundary component, and the sliding trace is distinguished as having a trace be sliding over the region portion, then a presetting action of the corresponding target action is executed.

By means of technical means of the present invention, it provides a control method which is different from the conventional clicking method. By the control method of the present invention, the touch control device executes an operating action by sliding a sliding trace and that whether the sliding trace passes through a boundary or not is distinguished. It thus requests less simplifies the processes of choosing a software object for a user. It further reduces the step, and saves the time and hardware resource while operating the touch control device. In addition, the operation of sliding control method is more intuitive, easier for operation, and brings more fun for a user.

### BRIEF DESCRIPTION OF THE DRAWINGS

The structure and the technical means adopted by the present invention to achieve the above and other objects can be best understood by referring to the following detailed description of the preferred embodiments and the accompanying drawings.

FIG. 1 is a flowchart illustrating the control method according to an embodiment of the present invention;

FIG. 2 is a schematic diagram illustrating a touch control device according to an embodiment of the present invention;

FIG. 3 is a block diagram illustrating a touch control device according to an embodiment of the present invention;

FIG. 4 is a schematic diagram illustrating the control method according to an embodiment of the present invention;

FIG. 5 is a schematic diagram illustrating a main page of the touch control device according to an embodiment of the present invention;

FIG. 6 is a schematic diagram illustrating a multimedia playing page of the touch control device according to an embodiment of the present invention;

FIG. 7 is a schematic diagram illustrating a keyboard inputting page of the touch control device according to an embodiment of the present invention;

FIG. 8 is a schematic diagram illustrating a photography capturing page of the touch control device according to an embodiment of the present invention;

FIG. 9 is a schematic diagram illustrating a signal transmitting page of the touch control device according to an embodiment of the present invention;

FIG. 10 is a schematic diagram illustrating a signal transmitting page of the touch control device according to an embodiment of the present invention;

FIG. 11 is a schematic diagram illustrating a signal transmitting page of the touch control device according to an embodiment of the present invention;

FIG. 12 is a schematic diagram illustrating a signal transmitting page of the touch control device according to an embodiment of the present invention;

FIG. 13 is a schematic diagram illustrating a musical instrument playing page of the touch control device according to an embodiment of the present invention;

FIG. 14 is a schematic diagram illustrating a keyboard inputting page of the touch control device according to an embodiment of the present invention;

FIGS. 15A-15L are schematic diagrams illustrating boundary components according to an embodiment of the present invention.

### DETAILED DESCRIPTION OF THE PREFERRED EMBODIMENTS

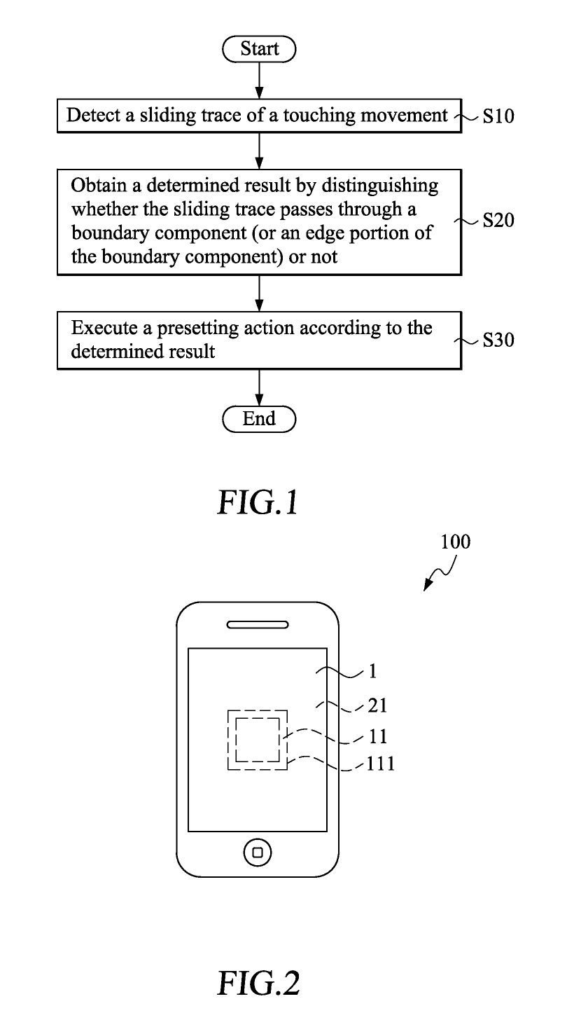

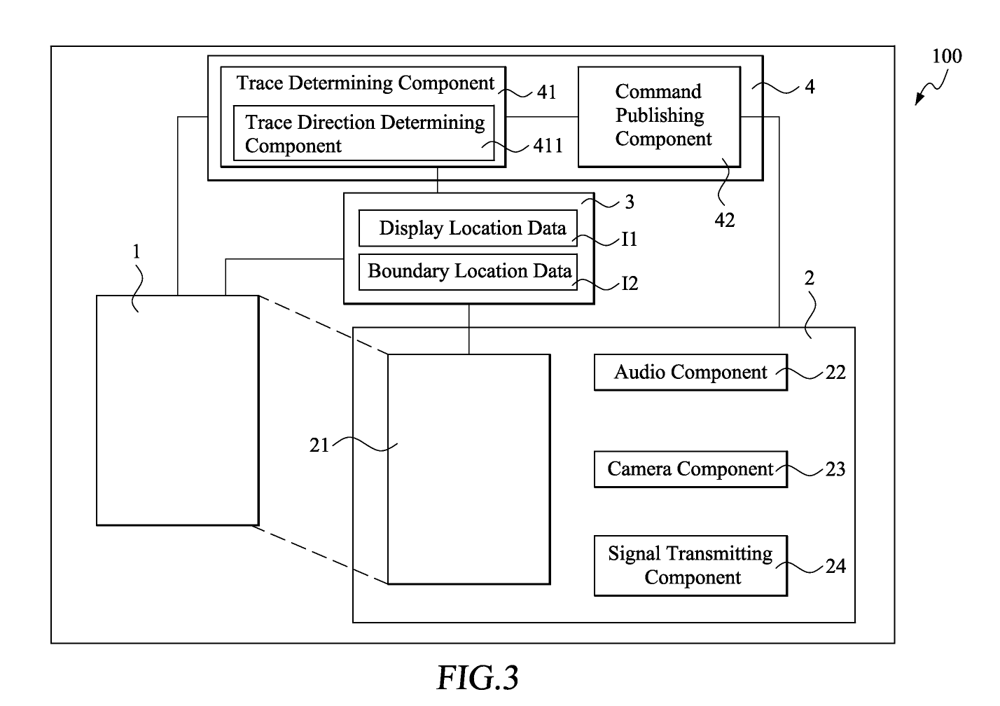

Refer to FIG. 1. FIG. 1 is a flowchart illustrating the control method according to an embodiment of the present invention. And also refer to FIGS. 2-4. The control method of the present invention is described as follows. The control method of the present invention includes steps as follows. While a touching movement is sensed on a touch panel of a touch control device, it detects a sliding trace of the touching movement (step S10); it obtains a determined result by distinguishing whether the sliding trace passes through the boundary component or not and by distinguishing whether the sliding trace passes through an edge portion of the boundary component or not (step S20); and it executes a presetting action according to the determined result (step S30).

Specifically, in general, the control method of the present invention is used for controlling a touch control device 100. The touch control device 100 may be a computer, a personal digital assistant, a satellite navigation device, or other devices with a touch panel.

In this embodiment, the touch control device 100 has a touch panel 1, an output input means 2, a location data storing component 3, and a control means 4. A display component 21 of the output input means 2 is coupled to the touch panel 1 and is stacked under the touch panel 1. The display component 21 has a visible area V for displaying a page. In this embodiment, the display component 21 is a screen, and the touch panel 1 is a transparent glass capacitance touch panel. The page within the visible area V of the display component 21 can be displayed through the touch panel 1. In other embodiments, the touch panel 1 also can be a resistance touch panel, an infrared ray touch panel, or the like. The location data storing component 3 electrically connects with the touch panel 1 and the display component 21, and the location data storing component 3 stores a display location data I1 and a boundary location data I2. In this embodiment, the display component 21 can display a plurality of the pages. The display location data I1 includes the location of the information that displays on each page of the display component 21. The boundary location data I2 includes a plurality of coordinate positions that displays on each page of the touch panel 1. It thus the touch panel 1 has a plurality of boundary components 11 according to the plurality of coordinate positions of the boundary location data I2 by means of the location data storing component 3. The display location data I1 and the boundary location data I2 may be relative to each other or not. The control means 4 includes a trace determining component 41 and a command publishing component 42. The trace determining component 41 electrically connects with the touch panel 1 and the location data storing component 3. The command publishing component 42 electrically connects with the trace determining component 41 and the output input means 2.

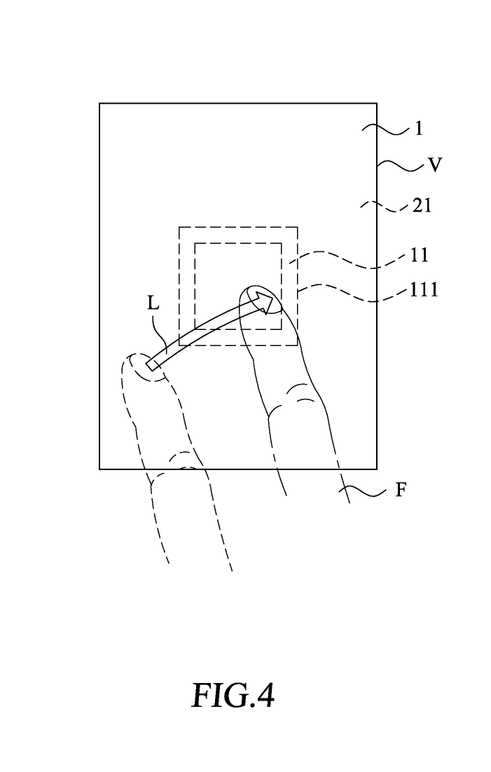

In the process of operation, the touch panel 1 is provided for detecting a sliding trace L of a touching movement of a user's finger F (or a touch pen) (step S10), as shown in FIG. 4. The trace determining component 41 distinguishes the sliding style of the sliding trace L that passes through the boundary component 11 or an edge potion 111 of the boundary component 11 for obtaining a determined result (step S20). And the command publishing component 42 sends a presetting command corresponding to the determined result to make the output input means 2 execute a presetting action according to the determined result (step S30).

In addition, in a preferred embodiment, in the step S20, it further includes a step of determining a direction of the sliding trace L passing through the boundary component 11 or a direction of the sliding trace L passing through the edge portion 111 of the boundary component 11 by a trace direction determining component 411 of the trace determining component 41.

The present invention provides the pages displayed by the display component 21 for describing the control method of the present invention as follows.

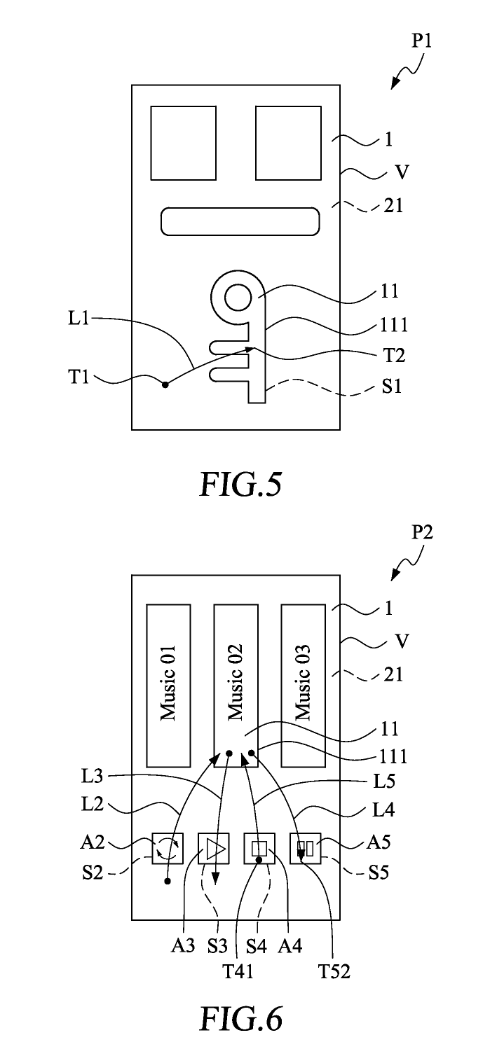

Refer to FIG. 5. The display component 21 displays a main page P1 through the touch panel 1. The main page P1 has a key symbol S1, and the touch panel 1 has a boundary component 11 that is allocated and is corresponding to the key symbol S1. In this embodiment, the sliding trace L1 does not completely pass through the boundary component 11. The sliding trace L1 only passes through the edge portion 111 of the boundary component 11. In other words, an initial touching point T1 of the sliding trace L1 does not locate within the boundary component 11, but an end touching point T2 of the sliding trace L1 does locate within the boundary component 11. In this embodiment, the touch panel 1 detects the sliding trace L1 (step S10). The trace determining component 41 distinguishes that the sliding trace L1 passes through the edge portion 111 of the boundary component 11 (step S20). And the command publishing component 42 sends a presetting command according to the determined result of the trace determining component 41 to make the display component 21 of the output input means 2 execute a presetting action that unlocks the main page P1 (step S30). However, the present invention is not limited to that. Alternatively, the output input means 2 can execute the presetting action when the sliding trace L1 completely passes through the boundary component 11. The output input means 2 also can execute the presetting action when the initial touching point T1 of the sliding trace L1 is located within the boundary component 11 and the end touching point T2 of the sliding trace L1 is not located within the boundary component 11.

Refer to FIG. 6. The display component 21 displays a multimedia playing page P2 through the touch panel 1. The multimedia playing page P2 has a repeat playing symbol S2, a playing symbol S3, a stop playing symbol S4, a pause playing symbol S5. The display location data I1 defines the location of the repeat playing symbol S2, the location of the playing symbol S3, the location of the stop playing symbol S4, and the location of the pause playing symbol S5. The touch panel 1 has a plurality of boundary components 11 corresponding to a multimedia information and has a target area A2, A3, A4, A5 respectively corresponding to the repeat playing symbol S2, the playing symbol S3, the stop playing symbol S4, the pause playing symbol S5 according to the display location data I1. The target area A2, A3, A4, A5 respectively correspond to corresponding target actions that make an audio component 22 of the output input means 2 play repeatly, play, stop playing, and pause playing, respectively. In this embodiment, the touch panel 1 detects the sliding trace L2 (step S10). The trace determining component 41 distinguishes that the sliding trace L2 passes through the target area A2 and then passes through the edge portion 111 of the boundary component 11 (step S20). It further makes the audio component 22 execute a presetting action that plays music repeatly (step S30). The touch panel 1 detects the sliding trace L3 (step S10). The trace determining component 41 distinguishes that the sliding trace L3 passes through the edge portion 111 of the boundary component 11 and then passes through the target area A3 (step S20). It further makes the audio component 22 execute a presetting action that plays music (step S30). The touch panel 1 detects the sliding trace L4 (step S10). The trace determining component 41 distinguishes that a initial touching point T41 of the sliding trace L4 locates within the target area A4 and the sliding trace L4 passes through the edge portion 111 of the boundary component 11 (step S20). It further makes the audio component 22 execute a presetting action that stops playing music (step S30). The touch panel 1 detects the sliding trace L5 (step S10). The trace determining component 41 distinguishes that the sliding trace L5 passes through the edge portion 111 of the boundary component 11 and a end touching point T52 of the sliding trace L5 locates within the target area A5 (step S20). It further makes the audio component 22 execute a presetting action that pause playing music (step S30).

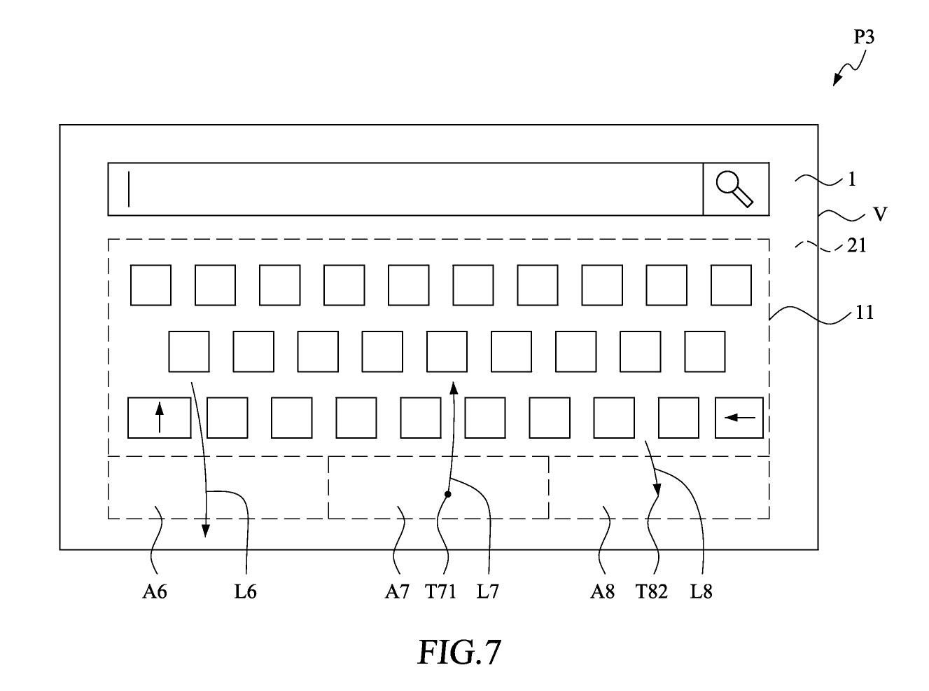

Refer to FIG. 7. The display component 21 displays a keyboard inputting page P3 through the touch panel 1. In this embodiment, the touch panel 1 has a boundary component 11 and target areas A6, A7, A8 that the boundary component 11 and the target areas A6, A7, A8 are hidden from view on the touch panel 1. The touch panel 1 detects the sliding trace L6 (step S10). The trace determining component 41 distinguishes that the sliding trace L6 passes through the boundary component 11 and then slides over the target areas A6 (step S20). It makes the command publishing component 42 send a presetting command of changing page to make the display component 21 execute a presetting action that makes the page change as a secondary keyboard inputting page (step S30). The touch panel 1 detects the sliding trace L7 (step S10). The trace determining component 41 distinguishes that a initial touching point T71 of the sliding trace L7 locates within the target area A7 and the sliding trace L7 passes through the boundary component 11 (step S20). It makes the command publishing component 42 publish a presetting command of changing page to make the display component 21 execute a presetting action that makes the page change as a Chinese (or English) keyboard inputting page (step S30). The touch panel 1 detects the sliding trace L8 (step S10). The trace determining component 41 distinguishes that the sliding trace L8 passes through the boundary component 11 firstly and a end touching point T82 of the sliding trace L8 locates within the target area A8 (step S20). It makes the command publishing component 42 publish a presetting command of changing page to make the display component 21 execute a presetting action that makes the page change as a numeric (or symbol) keyboard inputting page (step S30).

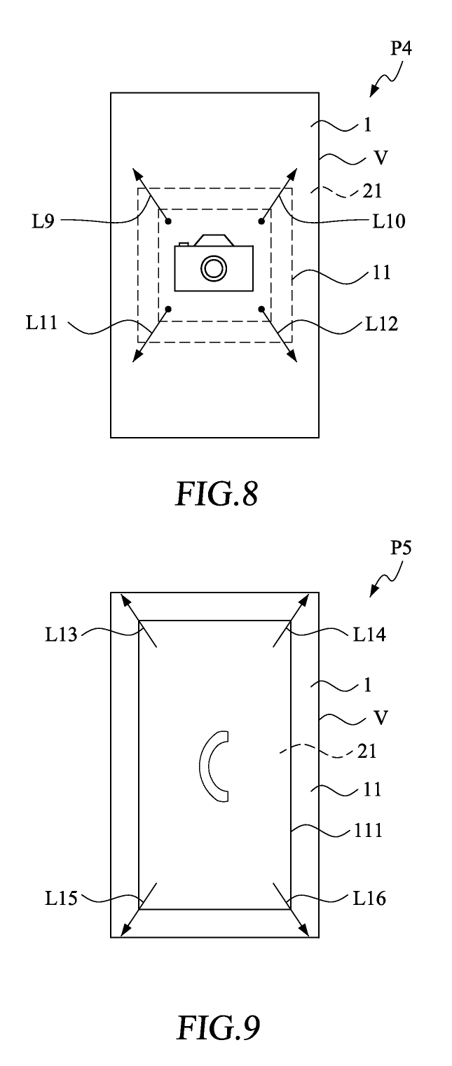

Refer to FIG. 8. The display component 21 displays a photography capturing page P4 through the touch panel 1. In this embodiment, in the step S20, the trace direction determining component 411 determines a direction of the sliding trace passing through the boundary component 11. In the step S30, the presetting action corresponds to the direction of the sliding trace passing through the boundary component 11. For example, the sliding traces L9, L10, L11, L12 pass through the boundary component 11 with different directions respectively so that a camera component 23 of the output input means 2 executes a presetting action of recording, a presetting action of photographing, a presetting action of automatically photographing in a presetting time, and a presetting action of scene setting, respectively. Of course, the present invention is not limited to that, in the step S20, the trace direction determining component 411 also can determine a direction of the sliding trace passing through the edge portion 111 of the boundary component 11. As shown in FIG. 9, the display component 21 displays a signal transmitting page P5 through the touch panel 1. In this embodiment, the boundary component 11 locates along the edge of the touch panel 1. The sliding traces L13, L14, L15, L16 pass through the edge portion 111 of the boundary component 11 with different directions respectively so that a signal transmitting component 24 of the output input means 2 executes a presetting action of calling up, a presetting action of hanging up, a presetting action of switching connection, and a presetting action of holding, respectively.

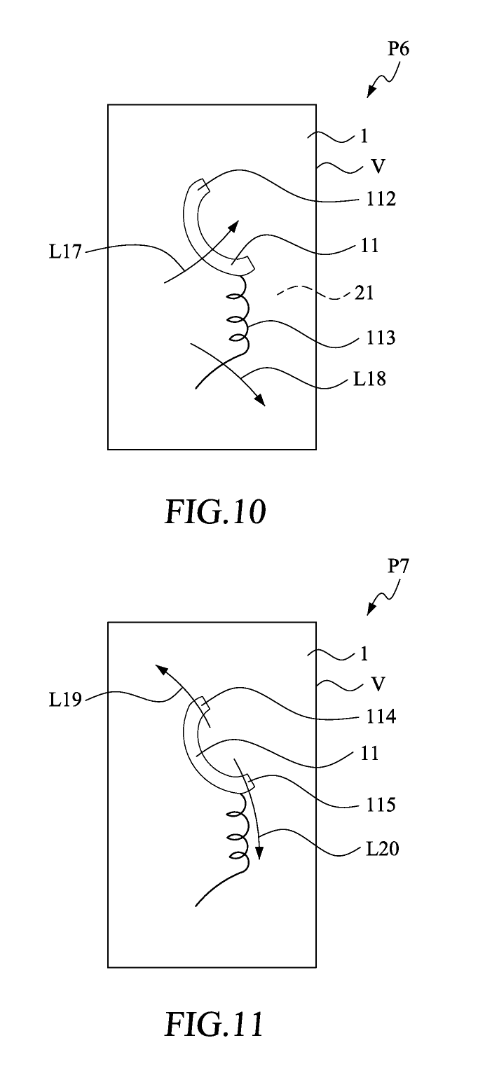

Refer to FIG. 10. The display component 21 displays a signal transmitting page P6 through the touch panel 1. In this embodiment, the boundary component 11 has a plurality of subsidiary boundary components 112, 113. The subsidiary boundary components 112, 113 respectively correspond to one of the target actions. In the step S20, the trace determining component 41 distinguishes that the sliding trace L17 passes through the subsidiary boundary components 112, and in the step S30, it makes the signal transmitting component 24 executes a presetting action of calling up. In the step S20, the trace determining component 41 distinguishes that the sliding trace L18 passes through the subsidiary boundary components 113, and in the step S30, it makes the signal transmitting component 24 executes a presetting action of hanging up.

Refer to FIG. 11. The display component 21 displays a signal transmitting page P7 through the touch panel 1. In this embodiment, the boundary component 11 has a plurality of subsidiary boundary components 114, 115. A user uses both of the subsidiary boundary components 114, 115 to correspond to an action of calling up. In the step S20, the trace determining component 41 distinguishes that the sliding trace L19 passes through the subsidiary boundary components 114 and the sliding trace L20 passes through the subsidiary boundary components 115, so that the signal transmitting component 24 executes a presetting action of calling up (step S30).

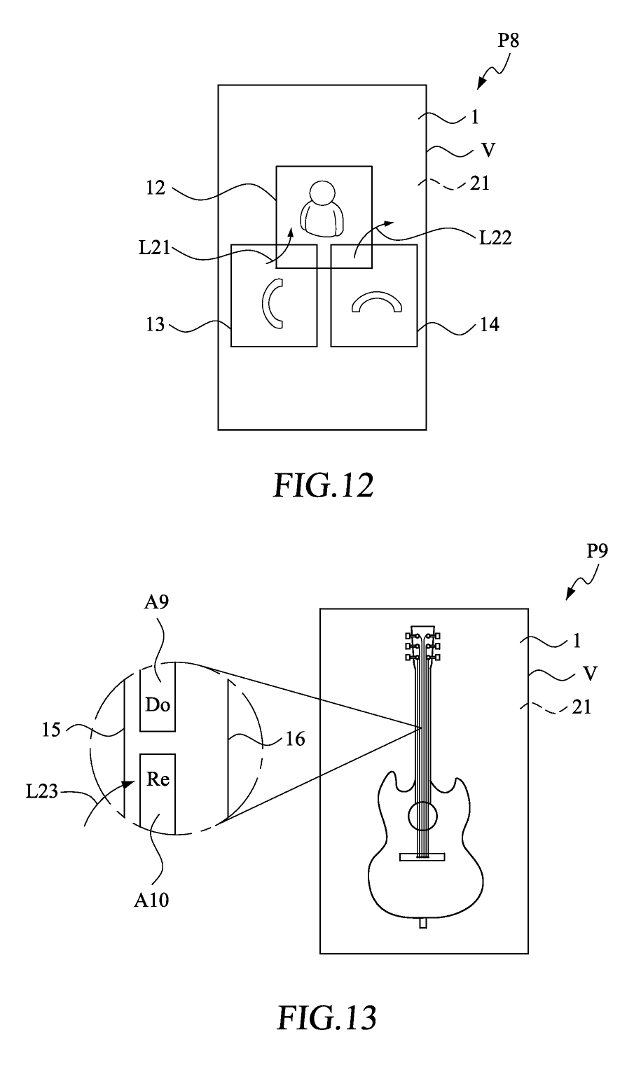

Refer to FIG. 12. The display component 21 displays a signal transmitting page P8 through the touch panel 1. In this embodiment, the touch panel 1 has a plurality of boundary components 12, 13, 14. The boundary components 12, 13 are overlapped with each other and are used together for corresponding to an action of calling up. In the step S20, the trace determining component 41 distinguishes that the sliding trace L21 passes through both the boundary components 12, 13, so that the signal transmitting component 24 executes a presetting action of calling up in the step S30. The boundary components 12, 14 overlapped with each other and are used for corresponding to an action of hanging up. In the step S20, the trace determining component 41 distinguishes that the sliding trace L22 passes through both the boundary components 12, 14, so that the signal transmitting component 24 executes a presetting action of hanging up in the step S30.

Refer to FIG. 13. The display component 21 displays a musical instrument playing page P9 through the touch panel 1. In this embodiment, the touch panel 1 has a plurality of boundary components 15, 16 and a plurality of target areas A9, A10. In the step S20, the trace determining component 41 distinguishes that the sliding trace L23 passes through the boundary component 15 and is nearest to the target area A10, so that the audio component 22 executes a presetting action to generate a guitar sound with tonic “Re” (step S30).

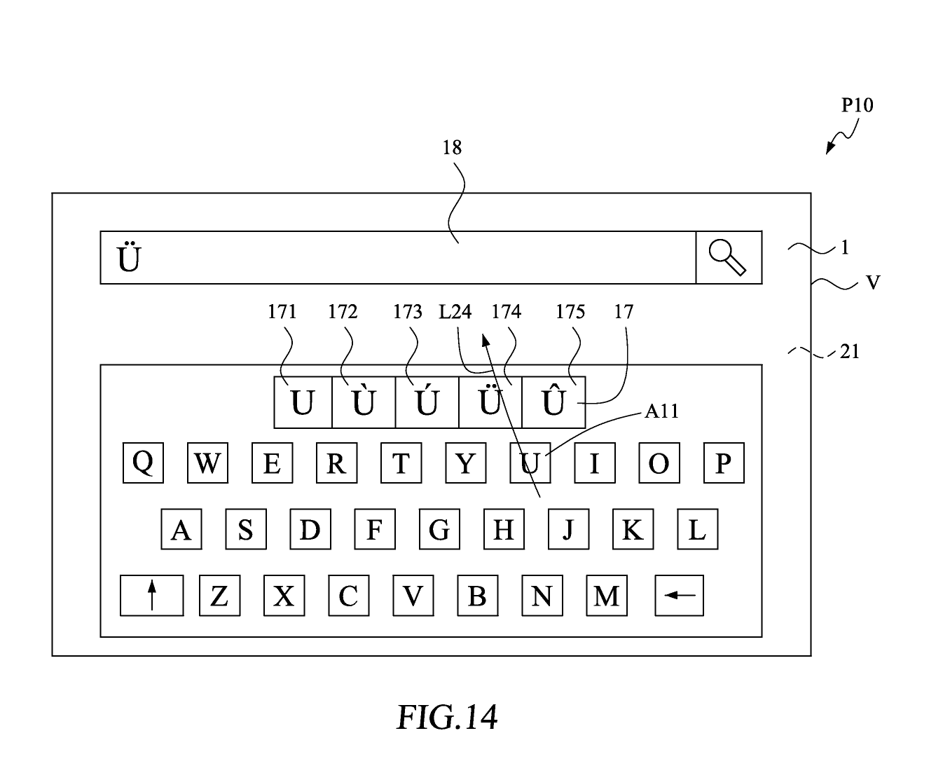

Refer to FIG. 14. The display component 21 displays a keyboard inputting page P10 through the touch panel 1. In this embodiment, the keyboard inputting page P10 is an English keyboard inputting page, and the touch panel 1 has a plurality of target areas A11 . . . for inputting English characters. In this embodiment, in the step S20, while the trace determining component 41 distinguished that the sliding trace L24 passes through the target areas A11 that is an area printed with an English character “U”, then a boundary component 17 is to be appeared on the keyboard inputting page P10. The boundary component 17 includes a plurality of region portions 171, 172, 173, 174, 175. In this embodiment, while the sliding trace L24 passes through the boundary component 17 and slides over the region portion 174, then it executes the presetting action corresponding to the region portion 174, that an English character “Ü” is inputted in a searching box 18 (step S30).

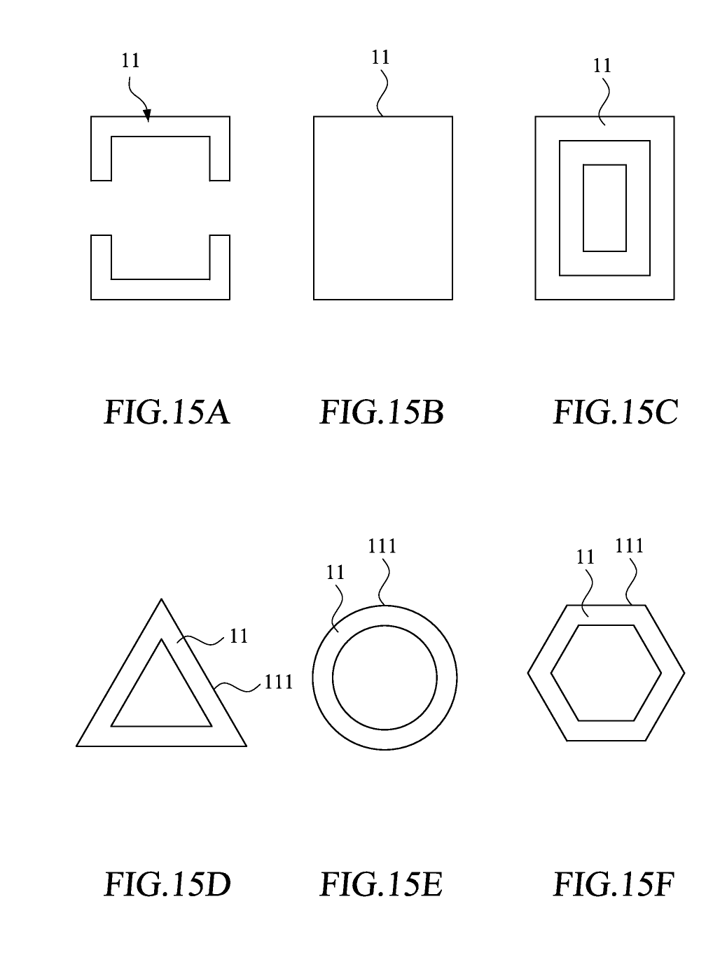

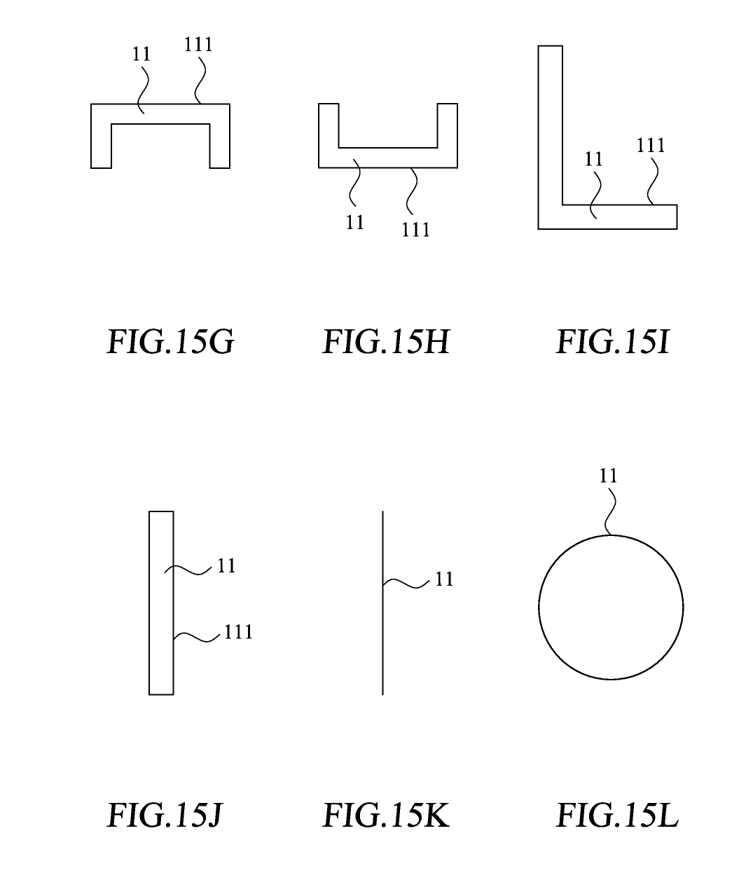

Of course, in addition to the shape of the boundary component 11, 12, 13, 14, 15, 16, 17 as mentioned above, the shape of the boundary component of the present invention also can be the shape selected from a group including frame-shaped form, strip-shaped form, and spot-shaped form, as shown in FIGS. 15A-15L.

The above description should be considered as only the discussion of the preferred embodiments of the present invention. However, a person skilled in the art may make various modifications to the present invention. Those modifications still fall within the spirit and scope defined by the appended claims.

What is claimed is:

1. A control method of touch control device for controlling a touch control device, the touch control device is provided with a touch panel, the touch panel is provided with a boundary component, the control method comprising steps of:
(a) detecting a sliding trace of a touching movement on the touch panel;
(b) obtaining a determined result by distinguishing whether the sliding trace passes through the boundary component or not and by distinguishing whether the sliding trace passes through an edge portion of the boundary component or not; and
(c) executing a presetting action according to the determined result.

2. The control method as claimed in claim 1, wherein the shape of the boundary component is a shape selected from a group including frame-shaped form, strip-shaped form, and spot-shaped form.

3. The control method as claimed in claim 1, wherein the boundary component appears on the touch panel or is hidden from view on the touch panel.

4. The control method as claimed in claim 1, wherein the touch panel is provided with a plurality of boundary components, at least two of the plurality of the boundary components are commonly used for corresponding to an execution action, and in the step (c) while the sliding trace is distinguished as having a trace be passing through a plurality of boundary components that commonly corresponding to an execution action, or the siding trace is distinguished as having a trace be passing through the edge portions of the plurality of boundary components that commonly corresponding to an execution action, then a presetting action that runs the execution action is executed.

5. The control method as claimed in claim 1, wherein in the step (b), it further includes a step of determining a direction of the sliding trace that passes through the boundary component or a direction of the sliding trace that passes through the edge portion of the boundary component.

6. The control method as claimed in claim 1, wherein the touch panel is provided with a target area, the target area corresponds to a corresponding target action, in the step (c) while the sliding trace is distinguished as having a trace be passing through the boundary component or through the edge portion of the boundary component, and the sliding trace is distinguished as having a trace be sliding over the target area, then a presetting action of the corresponding target action is executed.

7. The control method as claimed in claim 1, wherein in the step (c), the presetting action is a corresponding target action that corresponds to a target area nearest to the sliding trace.

8. The control method as claimed in claim 1, wherein the boundary component has a plurality of subsidiary boundary components, and each subsidiary boundary component corresponds to a corresponding target action respectively.

9. The control method as claimed in claim 1, wherein the boundary component has a plurality of subsidiary boundary components, and at least two of the plurality of the subsidiary boundary components commonly used for corresponding to a co-corresponding action.

10. The control method as claimed in claim 1, wherein the boundary component has a region portion, the region portion corresponds to a corresponding target action, in the step (c) while the sliding trace is distinguished as having a trace be passing through the boundary component or the edge portion of the boundary component, and the sliding trace is distinguished as having a trace be sliding over the region portion, then a presetting action of the corresponding target action is executed.
